(19) United States
(12) Patent Application Publication
(10) Pub. No.: US 2025/0002241 A1
(43) Pub. Date: Jan. 2, 2025

(54) METHOD FOR DEHYDRATING AN ITEM UTILIZING A MOISTURE REMOVING BAG

(71) Applicant: Kinzie Advanced Polymers, LLC DBA Grove Bags, Bedford Heights, OH (US)

(72) Inventors: Jacob GROVER, Bedford Heights, OH (US); Jiazhou Yang, Bedford Heights, OH (US)

(21) Appl. No.: 18/741,489

(22) Filed: Jun. 12, 2024

Related U.S. Application Data
(60) Provisional application No. 63/523,664, filed on Jun. 28, 2023.

(51) Int. Cl. B65D 81/26; B65D 75/20

(52) U.S. Cl. CPC B65D 81/266; B65D 75/20

(57) ABSTRACT

A method for dehydrating an object includes forming a container from a moisture wicking, air impermeable, polyvinyl alcohol sheet. The sheet is folded upon itself to form a folded structure having layer of the sheet in facing relationship with a second layer of the sheet. The first layer is sealed to the second layer along the length of a first open edge. The first layer is sealed to the second layer along the length of a second open edge; the opposed to the first open edge forming an open-ended container at a remaining open edge. An object to be dehydrated is placed in the container and the first layer is sealed to the second layer along the remaining layer.

### CROSS-REFERENCE TO RELATED APPLICATION

The present application claims priority to U.S. Provisional Patent Application Ser. No. 63/523,664, of same title, filed Jun. 28, 2023, the entire disclosure of which is incorporated herein by reference in its entirety for all purposes.

### TECHNICAL FIELD

The present application relates to moisture removing bags and is directed to a structure and method for providing and maintaining a dehydrating environment, and more particularly to dehydrating an item sealed within a container formed by a moisture removing material.

### BACKGROUND OF THE INVENTION

Technologies for removing moisture from the air or from objects have been known for centuries. Typically, these take the form of two technologies; dehydration and desiccant. These technologies have proved to be useful in various fields such as food preservation, pharmaceuticals, and electronics. However, current dehydration and desiccant technologies are not sufficient to meet the demands of modern industries.

Prior art dehydration techniques such as sun drying, oven drying, and freeze-drying require significant investment of energy, time, and space. Moreover, they often result in uneven drying and can damage the quality of the product being dried. Furthermore, dehydration can be unsuitable for use with many products. By way of example the prior art drying methods are not suitable for materials that are sensitive to heat, light, or air. Many fruits and vegetables lose their color, texture, and flavor when exposed to high temperatures or sunlight. Many pharmaceuticals and chemicals can degrade when exposed to oxygen and/or moisture.

Prior art desiccant technologies were developed to prevent the growth of mold, bacteria, and other microorganisms that can cause spoilage or contamination in a variety of settings. They are particularly useful in food storage, pharmaceuticals, and industrial processes, where the control of moisture is critical to maintaining product quality and shelf life. They make use of silica gel, activated carbon, or molecular sieves to remove moisture from the environment or product. However, they suffer from the disadvantage that they have limited moisture absorption capacity, and they need to be frequently replaced or regenerated. This leads to increased costs and greater environmental waste. Additionally, traditional desiccant technologies are also limited in terms of their selectivity and specificity. They cannot differentiate between different types of molecules and can absorb both water and other volatile compounds. This can affect the purity and efficacy of the final product.

The three most widely used types of desiccants on the market today are silica gel, activated charcoal, and molecular sieve. Each of these materials has its own unique properties and advantages, as well as drawbacks discussed below.

Silica gel is one of the most widely used desiccants, due to its high absorption capacity and low cost. It is effective at absorbing moisture from the air, and it can be easily recharged by heating it in an oven. However, silica gel suffers from the disadvantage that it can release moisture back into the air if it becomes saturated, which can lead to problems if the material is not properly maintained in a further moisture reducing/maintenance environment.

Activated charcoal is another popular desiccant, due to its high adsorption capacity and ability to remove a wide range of odors and gases. It is often used in air purifiers and dehumidifiers, as well as in food storage and pharmaceutical applications. However, activated charcoal also suffers from the saturation problem as found in silica gel.

A molecular sieve is a type of zeolite, a microporous, crystalline aluminosilicate, which is highly effective at absorbing moisture, and it is often used in industrial processes and pharmaceutical applications. It is particularly useful for controlling moisture in enclosed spaces, such as in packaging or storage containers. However, molecular sieves can be more expensive than other types of desiccants, and it may not be as effective at removing odors or gases as activated charcoal.

Accordingly, a structure and methodology which overcomes the shortcomings of the prior art is provided.

### SUMMARY OF THE INVENTION

A method for dehydrating an object includes forming a container from a moisture wicking, air impermeable, polyvinyl alcohol sheet. The sheet is folded upon itself to form a folded structure having a first layer of the sheet in facing relationship with a second layer of the sheet. The folded structure has a closed edge and three open edges. The first layer is then sealed to the second layer along the length of a first open edge. The first layer is then sealed to the second layer along the length of a second open edge; opposed to the first open edge, forming an open-ended container at a remaining open (top) edge. An object to be dehydrated is placed in the container and the first layer is sealed to the second layer along the remaining open top edge.

In one embodiment, the first layer is sealed to the second with a heat seal. In another embodiment, the seal may be formed as a laser seal. In yet another embodiment, the first layer may be sealed to the second layer using an adhesive.

In various embodiments, the object to be dehydrated may comprise seeds, a food product or a piece of electronic equipment. In the case of seeds and food products, the present method may be performed within a freezer or refrigerated environment.

### BRIEF DESCRIPTION OF THE DRAWINGS

The present disclosure will be better understood by reading the written description with reference to the accompanying drawing figures in which like reference numerals denote similar structure and refer to like elements throughout in which:

FIG. 1 a perspective view of a dehydrating package constructed in accordance with the invention, prior to insertion of materials;

FIG. 2 is a flowchart showing the method of dehydration in accordance with the invention;

FIGS. 3A, 3B are views of material being formed into the dehydrating package in accordance with the invention;

FIGS. 4A-4C are time elapsed perspective views of the dehydrating package dehydrating an item contained therein; and

FIG. 5 which is a sectional view of a single side of the dehydrating package along line 5-5 of FIG. 4B.

### DETAILED DESCRIPTION OF THE PREFERRED EMBODIMENTS

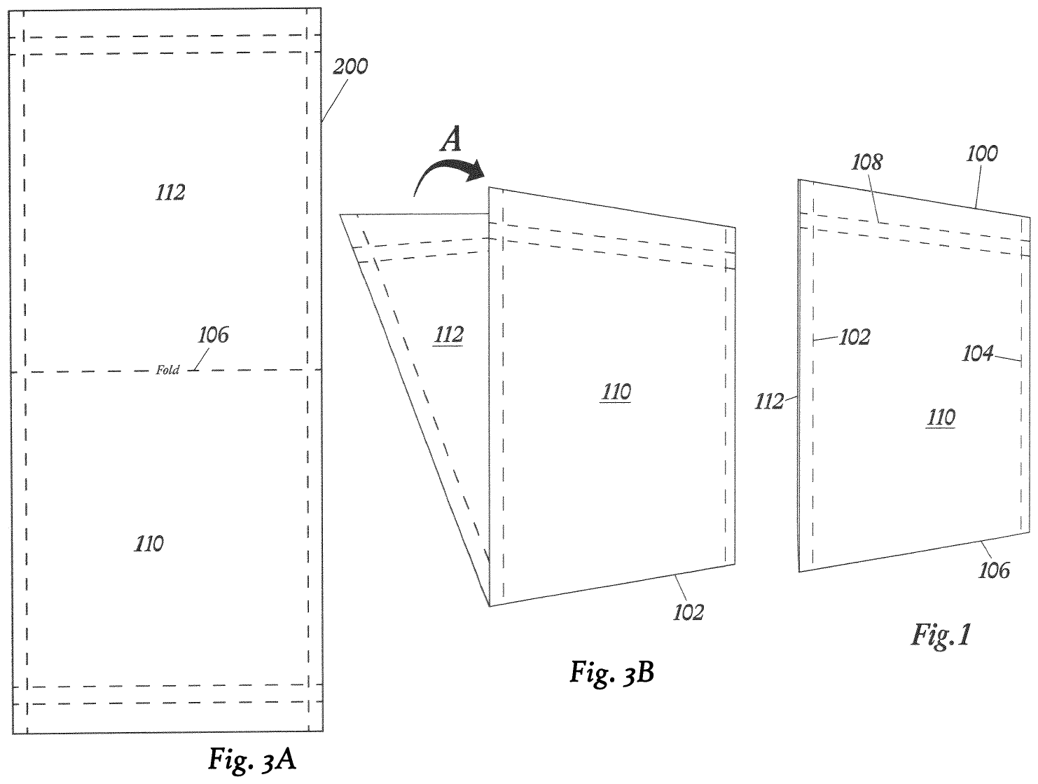

Reference is first made to FIG. 1 in which a container, or package, 100, prior to insertion of the material to be dehydrated, constructed in accordance with the invention is provided. As can be seen, in a preferred non limiting embodiment, container 100 is formed as a container, which remains open at one end for performance of the method as will be described below.

Container 100 has a first layer 110 and a second opposed layer 112, which when folded upon each other about fold line 106 in coextensive facing relationship, form a first sealed edge at fold line 106, a second sealed edge 102, and a third sealed edge 104, opposite second sealed edge 102. An open edge 108, for providing access to the interior of container 100 is provided along an edge opposed to first sealed edge 106.

Container 100 is formed of a desiccant infused air impermeable material such as a moisture wicking polyvinyl alcohol (PVOH), preferably the PVOH sold as Hydropol™. The film is breathable to moisture yet hydrophilic. The material is nontoxic so that it can be exposed to ingested products, does not degrade when exposed to UV light, and is water soluble.

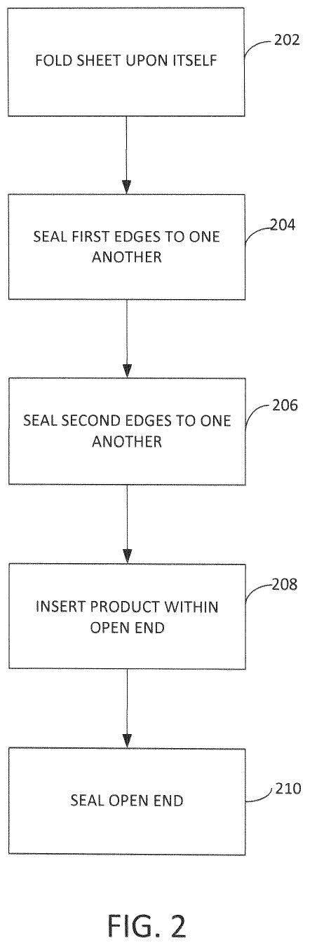

Reference is now also made to FIGS. 2 and 3A, 3B in which the method for dehydrating objects is provided. At step 202, a sheet 200 of the moisture extracting PVOH based monolayer film is folded upon itself (in the direction of arrow A), to be in facing relationship with itself, forming a first layer 110 and a second layer 112, and preferably with no overhang in a first step 202. The fold line 106 forms a first closed edge. The three remaining edges are unsealed or open.

In a step 204 the first layer 110 is sealed to the second 112 layer along a first open edge to form second sealed edge 102. In a step 204 the first layer 110 is sealed to the second layer 112 along a second open edge to form a third sealed edge 104 in a step 206. The second sealed edge 102 is the edge opposite the third sealed edge 104; the one just sealed. An open-ended container is the result of the first steps.

In a step 208 the product 400 to be dehydrated, in this example leaves, is inserted through the open end 108 of the container 100 into the container 100. In a step 210 first layer 110 is sealed to the second layer 112 along the open end 108; sealing the container 100. The result is a container which is air impermeable and removes the moisture from the product 400 contained therein. In a preferred nonlimiting embodiment, container 100 is a pouch in which the layers are sealed to each other by forming a heat seal. However, it is also within the scope of the invention to laser seal the edges or use an adhesive seal.

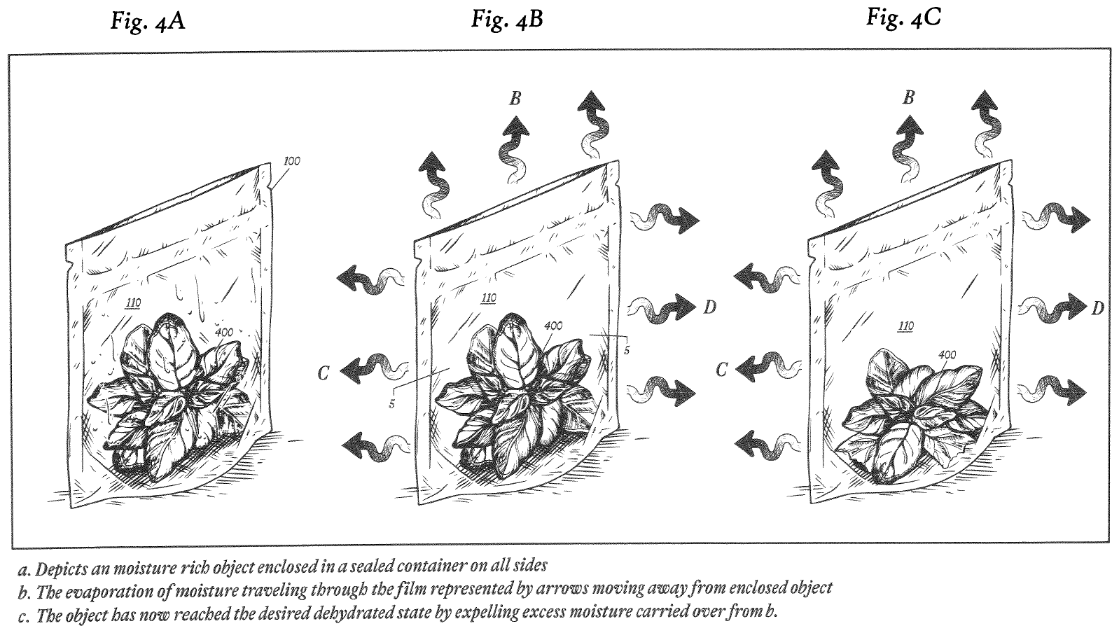

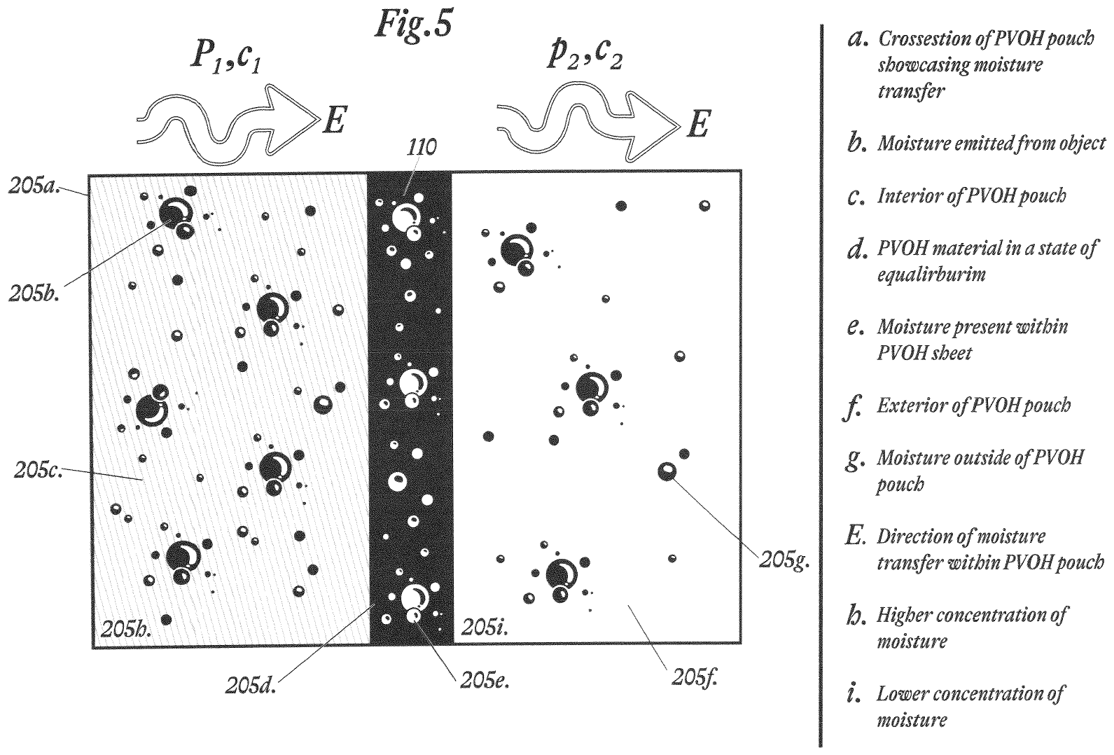

As seen in FIGS. 4A-4C and 5, the moisture is removed from the interior of the package to the exterior. Generally, as seen in FIGS. 4A-4C a moisture rich product, such as vegetation 400, and more specifically by way of non-limiting example, leaves, is disposed within container 100. Over time the vegetation 400 becomes dehydrated by container 100 removing moisture from within the bag, as seen by arrows B, C, D, to outside the bag; which includes moisture within vegetation 400. As such, FIG. 4A depicts a moisture rich object first sealed into the pouch container 100. FIG. 4B depicts the evaporation of moisture travelling through the film of the container (as illustrated by arrows B, C and D). Finally, FIG. 4C illustrates the final desired dehydrated state of the object in container 100.

More particularly as shown in FIG. 5, moisture is “off gassed”, passed through the container 100 in the direction of arrows E, from within container 100 (left side of FIG. 5) to the exterior of container 100 (right side of FIG. 5). There is a higher concentration of moisture in the vegetation 400 then in the (exterior, ambient) atmosphere 205f surrounding container 100. As a result of the nature of the layers, such as layer 110, shown in FIG. 5, moisture 205b is emitted from the object, such as vegetation 400, as it is drawn by layer 110. PVOH material 205d of layer 100 is at equilibrium having moisture 205e passing therethrough, while during dehydration there is a higher concentration of moisture 205b in an interior 205c of container 100 than within material 205d or moisture 205g outside of container 100. As a result, moisture travels in the direction of arrows E from vegetation (not shown) within container 100 through the layers 101,102 of container 100 to the exterior of 205f of container 100.

In a preferred embodiment, film 200 is a large monolayer of Hydropol™ film that is from 0.001 inch to ¼ inch thick, that as discussed above, is first folded over itself and then heat sealing three sides of the folded structure to create a container with an interior dimension of about 9×6 inches. The fourth side will be left open. A target object 400 that will be dried is placed inside the container bag 100. The fourth side is heat sealed to create an airtight bag. The water present in the object will evaporate into the air inside the bag, and then be adsorbed and then diffused through the PVOH material of the container 100. This process has no limitation to the amount of water that the material can off-gas if both the atmospheric conditions and the stored objects meet certain criteria.

The difference of the vapor pressures inside and outside the bag will create an equilibrium moisture transfer rate. This rate will be higher than 0. This equilibrium is affected by ambient environmental temperature, environmental humidity levels, the volume inside the bag, the interior surface area of the bag, the starting moisture content of the stored object, and the density of the object. In one trial, using pure water in a cup, this material has around fourteen times the ability to remove water from inside the bag as compared to a common polyethylene material and seven times that of a material containing a type of desiccant.

In its various aspects, the present method may be performed within a freezer or refrigerated environment. The advantage of working at these temperatures is reduced humidity in the ambient air surrounding the container, further promoting the desired dehumidification effect, while still avoiding freezer burn (in the case of foodstuffs). The present application is not limited to freezing or refrigerated environments. For example, in preferred aspects, the present method may be carried out at a temperature range from −6 F to 72 F. Lower temperatures are also possible, all keeping within the scope of the present invention.

### Examples of Prior Art Dehydration Techniques

### I. Seed Storage

Moisture, temperature, and the proportion of oxygen are key environmental factors that affect seed deterioration and loss of viability. Reducing seed moisture content (MC) to certain thresholds increases longevity in a predictable manner for approximately 90% of species (Roberts 1973). These species are classified as being “orthodox” in their seed storage requirements, and generally retain viability and germinability even after proper storage for long periods under suitably dry, cool conditions.

In at least one embodiment the prior art makes use of glass vials or tubes requiring several steps of preparation and specific materials. Glass tubes, preferably alkaline, are used. A precise quantity of seeds, as a function of the tube volume, is then placed in the tube. Cotton, preferably hydrophobic, and previously dehydrated, is then placed in the tube adjacent to the seeds. Then dehydrated silica gel is placed in the tube so that the cotton is disposed between the tube and the gel. The tube is then sealed with a rubber cap for a period of days. The tube may then be heat sealed.

In general, for each 1% decrease in seed moisture (when seed MC ranges between 5 and 14%) and for each 5° C. decrease in storage temperature (between 0° C. and 50° C.) the life of the seed is doubled (Harrington 1972). Basic principles for orthodox seed storage are thus, low seed MC and low temperature. For their short-term storage (<18 months; Hong & Ellis 1996), a temperature between 0° C. and 5° C. is sufficient to maintain the viability of dry seeds. For longer periods of storage, seeds should be stored at −18° C. to −20° C. (Hong & Ellis 1996). Seeds should be dried to 3-7% MC (fresh weight basis; see below) and placed in airtight containers (Food and Agriculture Organization (FAO)/International Plant Genetic Resources Institution 1994).

Other methodologies, such as the one currently used by UNIVERSIDAD POLITÉCNICA DE MADRID Plant Germplasm Bank take the concept of drying even further and provides a new target of 1-3% MC, achieved with the assistance of silica gel beads. This methodology has been shown to achieve 95%+ germination rates after four decades.

Utilizing the container constructed in accordance with the present invention advantageously allows for seeds to be stored under these optimal conditions without hassle or the need to gather multiple components and materials, or perform a series of intricate steps, by the person doing the drying, to create the dehydrating package.

### II. Fresh Frozen Plant Materials

Freezer burn is a condition that occurs when frozen food is exposed to air, causing moisture to evaporate from the surface of the food during the freezing process. The same process can happen to plant matter that is stored in a freezer, including plant leaves, stems, and other plant parts. Freezer burn can affect plant matter structurally in several ways. One of the primary effects is that it can cause the plant cells to lose moisture, which can lead to the plant matter becoming dry and brittle. This can be particularly damaging to plant leaves and other delicate plant parts.

Cellulose, which is the primary component of plant cell walls, can be affected by freezer burn. Cellulose is a complex polysaccharide that provides structure and support to plant cells. When plant matter is freezer burned, the cellulose fibers can become damaged or broken, which can lead to structural changes in the plant. Trichomes, which are small hair-like structures found on the surface of many plant parts, can become damaged or ruptured, which can lead to the loss of these compounds and changes in the plant's aroma and flavor. Chlorophyll, which is the pigment that gives plants their green color and is essential for photosynthesis, accelerates the breakdown of chlorophyll, which can cause plant matter to lose its green color and turn brown or black.

The present invention allows for the frozen plant materials to avoid freezer burn by actively removing water from the plant material until it is frozen, thereby removing freezer burn. While prior art U.S. Pat. No. 6,391,224B1 has demonstrated an application for inhibition of ice growth, it teaches using the material as an additive in a solution as compared to the present invention using it solely as a barrier packaging.

### III. Electronics

ESD or Electrostatic Discharge can cause damage to electronic goods in several ways. When an ESD event occurs, a high voltage is discharged between two objects, creating a rapid and intense electrical current that can heat up and ionize the surrounding air. This can generate electromagnetic fields that induce a voltage on nearby conductors, which can cause current to flow through the electronic components and circuits, potentially damaging or destroying them. The high voltage and current generated by an ESD event can also create localized heating, which can melt or vaporize small parts of the electronic components, such as the metal interconnects, dielectric layers, or junctions, leading to permanent damage or failure of the components. ESDs can be classified into several effects.
1. The triboelectric effect: This is the phenomenon where static electricity is generated when two materials with different electrical properties come into contact with each other. For example, when a person touches a doorknob after walking across a carpeted floor, the person's body can become negatively charged with respect to the doorknob.
2. The corona effect: This occurs when there is a difference in potential between two points, causing a flow of electrons from one point to the other. This can cause the formation of ions and free electrons, which can damage sensitive electronic equipment.
3. The spark discharge: This occurs when there is a sudden breakdown of the electric field, resulting in a spark or discharge of static electricity. This can cause damage to electronic components, especially in high-voltage systems.
4. The electret effect: This is a phenomenon where static electricity is generated when a material becomes charged through the application of an electric field. This can occur in materials such as foam or fabric and can cause damage to sensitive electronic equipment if proper precautions are not taken.

These ESD events can cause latent damage, which is damage that does not immediately manifest as a failure, but instead weakens the electronic components over time, leading to failures that occur at a later time, possibly after the device has been shipped to the customer or installed in the field.

Moisture contributes to an environment facilitating ESDs. To reduce or eliminate moisture, current storage conditions for electronics include an antistatic bag and sometimes, also a desiccant usually of silica gel beads however, they have limited life spans and require some type of barrier between the gel and electronics. In contrast, the present invention will be able to protect electronics from moisture and ESD related losses, as the inventive PVOH container of the present invention is inherently static dissipative.

As can be seen from the above, by constructing a container in accordance with the present invention, a structure for dehydrating objects and maintaining a substantially moisture free condition which overcomes the shortcomings of the prior art is provided.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

1. A method of dehydrating an object, comprising:
providing a sheet of polyvinyl alcohol;
folding the sheet of polyvinyl alcohol upon itself to form a folded structure having a first layer of the sheet in facing relationship with a second layer of the sheet;
attaching the first and second layers of the sheet of polyvinyl alcohol together along a first open edge;
attaching the first and second layers of the sheet of polyvinyl alcohol together along a second open edge;
placing an object to be dehydrated into a container formed by the first and second layers of polyvinyl alcohol being folded or attached together; and
attaching the first and second layers of the sheet of polyvinyl alcohol together along a third open edge.

2. The method of claim 1, wherein the first and second layers are attached together along the first and second open edges by heat sealing the first and second layers together.

3. The method of claim 1, wherein the first and second layers are attached together along the first and second open edges by laser sealing the first and second layers together.

4. The method of claim 1, wherein the first and second layers are attached together along the first and second open edges by adhesives.

5. The method of claim 1, wherein the sheet of polyvinyl alcohol is rectangular and the first and second open edges are on opposite sides of the rectangular sheet.

6. The method of claim 1, wherein the object to be dehydrated is a plant or vegetation material.

7. The method of claim 1, wherein the object to be dehydrated is electronic equipment.

8. The method of claim 1, wherein the polyvinyl alcohol sheet is approximately 0.001 inch to ¼ inch thick.

9. The method of claim 1, wherein the method is carried out within a freezer or refrigerated environment.

10. The method of claim 1, wherein the method is carried out at a temperature range from −6 F to 72 F.

11. A method for dehydrating an object comprising the steps of:
forming a container from a moisture wicking, air impermeable, polyvinyl alcohol sheet;
by folding the sheet upon itself to form a folded structure having a first layer of the sheet in facing relationship with a second layer of the sheet; the first layer is sealed to the second layer along the length of a first open edge; the first layer is sealed to the second layer along the length of a second open edge; the second open edge being on an opposite side of the sheet to the first open edge forming an open ended container at a remaining open edge;
an object to be dehydrated is placed in the container; and
the first layer is sealed to the second layer along the length of the remaining open edge.

12. The system of claim 11, wherein the first layer is sealed to the second layer by a heat seal.
